(19) United States
(12) Patent Application Publication
(10) Pub. No.: US 2007/0204803 A1
(43) Pub. Date: Sep. 6, 2007

(54) Method and apparatus for wireless message transmission using device worn by animal

(76) Inventor: Sheldon C. Ramsay, Piedmont, CA (US)

Correspondence Address: THELEN REID BROWN RAYSMAN & STEINER LLP, P. O. BOX 640640, SAN JOSE, CA, 95164-0640, US

(21) Appl. No.: 11/369,284

(22) Filed: Mar. 6, 2006

(51) Int. Cl. A01K 15/04

(52) U.S. Cl. 119/720

(57) ABSTRACT

A system for communicating information between a handler at a first location and an animal at a second location includes a local communication unit operated by the handler, and a remote communication unit mounted to the animal. The handler initiates messages, which can be visual or auditory (for example live or pre-recorded voice or tones), or in other forms, and transmits signals corresponding to these messages to the animal, or a person, such as a rescuee, in the vicinity of the animal. In this manner the handler gains communication access to locations the animal has reached, which locations may otherwise be inaccessible to the handler. The remote unit may also be configured to provide information back to the handler, such location information and visual and/or sound information of the environment to which the wearing animal has transported the remote unit. Such information is useful for facilitating a rescue effort, identifying dangerous conditions, and so forth.

### FIELD OF THE INVENTION

The present invention relates to wireless transmission of messages, and more particularly, to wireless transmission of messages between a local communication unit operated by an animal handler and a remote communication unit worn by the animal.

### BACKGROUND OF THE INVENTION

Throughout human history, animals have played important roles in peoples' lives. Besides their obvious use as food, animals have provided labor, transportation, companionship, and have assisted humans in hunting and herding. One important role that animals play in modern society involves search-and-rescue operations. Animals, primarily dogs, can often enter into places that are too remote, rugged, or dangerous for a human rescuer. A dog's keen senses of smell and hearing are invaluable in aiding to locate trapped, injured or lost victims. However, once a dog does find a such a victim, there is a limit as to how much information can be communicated to or from the victim. It would be useful to have a way to communicate information to a victim, and also have a way for victims to communicate information back to the human rescuers, so that the human rescuers can be advised of and prepared to handle medical or other conditions, or be warned of dangers or other issues related to the rescue. Providing information, instructions or simply comfort to the victim in these situations can be very important.

In more casual applications, it will be appreciated that animals are helpful in initiating contact and conversation between people. Pets such as dogs are, unlike their owners, typically uninhibited about approaching other people, or other pets and their owners. In addition, people are generally initially more receptive to strange or unknown animals than they are to strange or unknown people. Thus owners can rely on a pet to “break the ice” with a stranger, gaining an entrée so that the owner can then initiate an interaction with the stranger.

Thus it would be useful to exploit these unique abilities of animals to facilitate tasks such as search and rescue, or mere social interaction.

### SUMMARY OF THE INVENTION

In accordance with the invention, there is provided a communication system that includes a local communication unit and a remote communication unit in wireless communication with each other. The remote communication unit is configured to be mountable to an animal and to present to the animal or to a person in the vicinity of said animal an action that is initiated at the local communication unit.

Further in accordance with the invention, there is provided a remote communication unit configured for wireless communication with a local communication unit. The remote communication unit includes a mounting portion for mounting the remote communication unit to an animal, a communication circuit configured to receive signals from the local communication unit, and at least one transducer for presenting information to the animal or to a person in the vicinity of the animal in response to the received signals.

Further in accordance with the invention, there is provided a local communication unit configured for wireless communication with a remote communication unit adapted for mounting to an animal. The local communication unit includes an input device through which an operator initiates an activity at the remote communication unit, and a communication circuit configured to send signals associated with the activity to the remote communication unit.

Further in accordance with the invention, there is disclosed a communication method including initiating a message at a first location, and presenting the message at a second location using a transducer mounted to an animal.

Further in accordance with the invention, there is disclosed a communication system that includes a means for initiating a message at a first location, and means for presenting the message at a second location using a transducer mounted to an animal.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 is a diagrammatic view of a system in accordance with the invention, including a local and remote communications units which are shown mounted on a collar;

FIG. 2 is a block diagram showing some details of a remote communications unit in accordance with the invention;

FIG. 3 is a diagrammatic view a system in accordance with a further aspect of the invention; and

FIG. 4 is a front elevational view of a local handheld communications unit in accordance with the invention.

### DETAILED DESCRIPTION OF THE INVENTION

Embodiments of the present invention are described herein in the context of a method and apparatus for wireless transmission using device worn by an animal. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

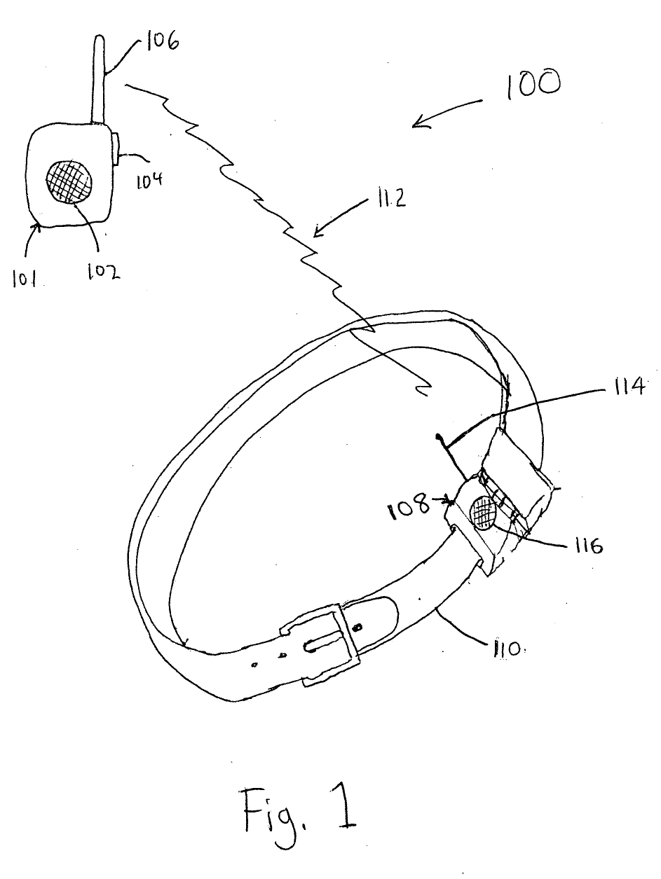

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with governmental or application- and business-related constraints, and that these specific goals will vary from one implementation to another and from one developer to another. In accordance with the invention, a system 100 for effecting communication between an operator or handler and an animal is shown in FIG. 1. The term “handler” will be used to not only include the standard definition of an animal handler, but will also include pet owners and others who are interacting with the disclosed invention. System 100 includes a handheld wireless local communication unit 101 having a microphone 102 for voice pick-up, a push-to-talk switch 104, and an antenna 106. The handheld wireless local communication unit 101 is shown as a standalone unit, but it will appreciated that its functionality can instead be integrated into other devices. Standard circuitry and other components (not shown) are provided to enable the operator or handler to communicate message wirelessly from local communication unit 101 to a remote communication unit 108 disposed on collar 110. The operator speaks into microphone 102, which converts the operator's voice to electrical signals. In accordance with standard practice, these are then amplified and converted to RF (radio frequency) signals which are transmitted by antenna 106, typically in modulated form. The RF transmissions may be terrestrial or satellite transmissions, and are conducted consistent with existing regulatory constraints. The frequencies and applications of the wireless transmission are preferably different from those used in cellular communication. Thus reliance on the cellular infrastructure is preferably avoided, particularly in applications involving emergency/rescue situations in which, for example due to remoteness, cellular reception may be compromised. This may not always be the case, and it is contemplated that in other situations and applications, cellular networks can provide an expedient means for the signal transmission.

Prior to speaking, the operator can depress switch 104 to activate the circuitry. Alternatively, voice activation circuitry (not shown) can be employed in lieu of switch 104 for purposes of convenient operation and/or battery power conservation. The RF signals (denoted at 112) representative of the operator's voice are emitted substantially in real-time by antenna 106 and received by remote unit 108. It will be appreciated that while explained primarily in terms of the operator's voice, other signals and information can also be conveyed wirelessly and in substantially the same manner, including signals designed to trigger different types of alarms or pre-recorded messages stored and/or generated by either local unit 101 or remote unit 108.

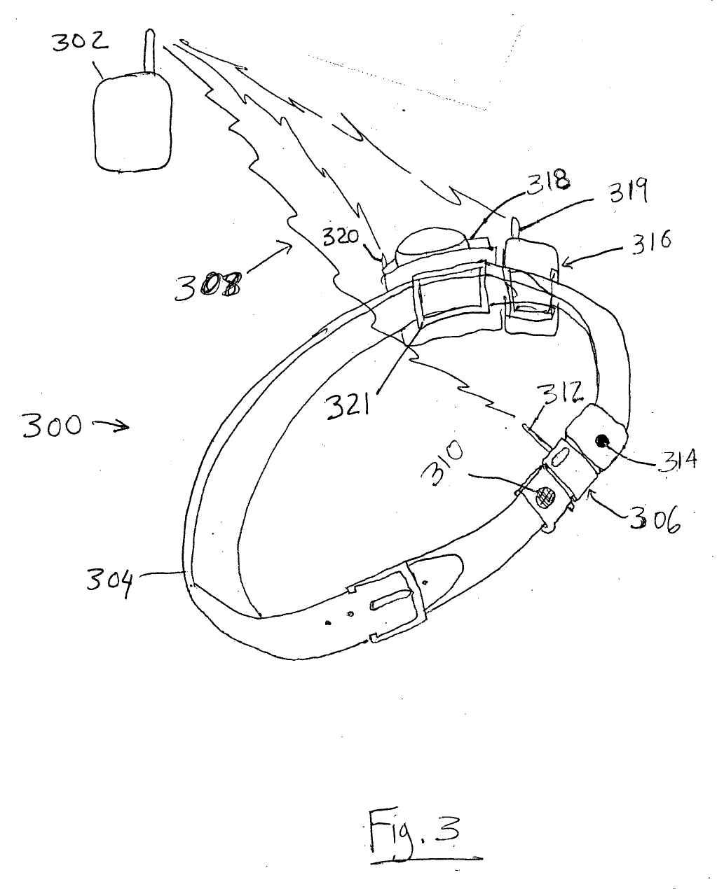

Remote communication unit 108 is detachably mounted to collar 110, which is configured to be worn by an animal, for example around the neck of a dog. A mounting portion (FIG. 3) is provided, for example in the form of loops though which the collar 110 passes, or complementary disengageable snaps provided on both the unit 108 and collar 110, or Velcro™, buttons, straps, ore other means of detachably coupling the two components. While described in terms of attachment to a collar, it will also be appreciated that communication unit configurations, for example those consistent with attachment to and/or integration with harnesses, backpacks, saddles, headbands, ear clips, body bands, leg bands, chest plates, saddle bags pouches and so forth, are of course possible, and would be designed to comfortably and securely conform to the size, anatomy and disposition of the animal. In addition, the remote unit 108 could be built into a bag or other attachment (not shown) so that it can be attached to an existing collar, harness, or saddle. Further, unit 108 may be built into a headphone, earplug, or implant, and may be permanently attached, removably attached or integrated into a collar, harness, saddle or the like.

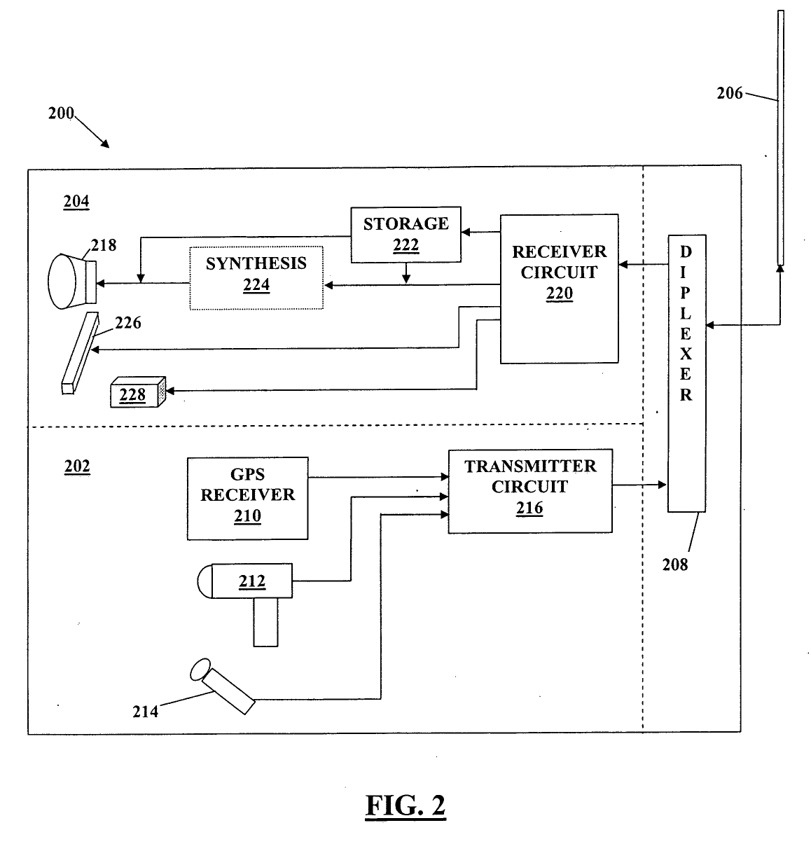

Antenna 114 receives RF signals 112, which are then conveyed to appropriate circuitry (115, FIG. 2) which amplifies (and demodulates) them, for, in the case of voice signals, conversion into audible signals by speaker (or loudspeaker) 116. The converted audible message can then be heard by the animal wearing the device, or by people and/or animals in the vicinity thereof. It is contemplated that the volume from speaker 116 can be controlled and can alternatively be made sufficiently low to be audible exclusively to the animal, so that system 100 can be operated to provide commands to the animal to which people or other animals in the vicinity may not be privy. Alternative methods for accomplishing this is using speakers (not shown) implanted in the animal's ear canal or other locations, headphones placed over the animal's ears, ear phones, ear clips, and so forth. The volume and location of speaker 116 and remote unit 108 are also managed so as to avoid interference from ambient noise, by for example disposing the speaker close to the wearing animal's ear. Volume control of speaker 116 can be effected remotely from unit 101, or locally, using a suitable knob (not shown) located on unit 108.

While the various components of remote communication unit 108 are shown as being integrated into the same device and sharing a common housing, this is optional, and it is contemplated that these components can be separated out, for example a separate power pack (not shown) disposed elsewhere in the collar 110 for better accessibility, an antenna 114 that is located, either fixed or adjustable, in a more prominent location for improved signal reception, a speaker disposed closer to the animal's ear, and so forth.

The system of the invention can optionally be provided with other features, as described with reference to FIG. 2, which is a block diagram of a remote communication unit 200 similar to unit 108. An information acquisition portion 202 and an information presentation portion 204 are each coupled to an antenna 206 by way of a diplexer circuit 208. Information acquisition portion 202 includes a GPS (global positioning system) receiver 210, camera 212, and microphone 214. These devices gather information from the surroundings of communication unit 200 and convey this information wirelessly to local communication such as unit 101 described above, transmission circuit 216. Specifically, position information indicative of the location of unit 200 is acquired by GPS receiver 210 and communicated to the handler at the local communication unit. Such location information can have obvious advantages, for example when worn by rescue dogs. Video information, which may be still or moving footage, is obtained by camera 212, and sound information is obtained by microphone 214. The video and sound information are also communicated to the handler at the local unit.

Information presentation unit 204 is serves to present information at remote unit 200. Such information can be live (real-time) or pre-recorded voice messages presented by speaker 218. Live messages are provided by a person such as the handler speaking into the microphone of the local communication unit, which transmits these wirelessly to remote unit 200. Antenna 206 receives the wireless RF signals, which are suitably conditioned/filtered by diplexer 208 and forwarded to receiver circuit module 220 and on to speaker 218 for re-conversion to sound signals. Pre-recorded messages that originate at the local communication unit, which would be configured to store such messages in any known medium, for example in a magnetic, optical or electronic (RAM/ROM/EPROM/flash memory) form, are similarly wirelessly transmitted for presentation at remote unit 200 by speaker 218. Alternatively, similar storage can be provided by a storage device 222 disposed in remote unit 200, and the message can be read from the storage device at the instigation of an action, such as the press of a button, at the local unit. A synthesizer module 224 can optionally be provided upstream of speaker 218 in order to alter the sounds or voices from the speaker. For instance, if the collar on which remote communication unit 200 is to be worn by a large dog, the voice synthesizer module 224 can operate to modify the voice message so that the voice was played deeper or gruffer in tone, as if the large dog itself were speaking. Similarly, if the collar 110 was being worn be a small dog, the voice synthesizer module could modify the voice message so that the voice was played higher in pitch and softer in tone. Control of the synthesizer tone, pitch and other parameters can be conducted remotely via the local communication unit, or it can be conducted using input devices such as knobs, switches and so forth provided on unit 200. It will be noted that both the live and pre-recorded messages can be passed through the synthesizer 224. It will also be noted that sounds presented by speaker 218, or by other such transducers (not shown), are not restricted voice messages. Instead (or in addition), tones can be presented, which the hearer, including the wearing animal, can interpret based on pre-agreed conditions or training. Such tones can be useful in order to maintain secrecy of communication, as others within hearing range may not be privy to their meaning, which can be useful in some situations.

In addition to audible signals, visual messages and signals can be presented by presentation unit 204. For example, a bank of LEDs 226 can be provided, and patterns of these LEDs can be activated depending on the message intended to be conveyed. Activation of the LEDs, or other visual transducers such as incandescent lights and so forth, can be conducted remotely by the handler at the local communication unit. Other forms of signaling can be achieved using a vibration transducer 228 to provide vibrations of pre-selected frequencies, amplitudes, and so forth to which the wearing animal can be trained to respond.

It will be appreciated that FIG. 2 is a high-level diagrammatical illustration of one manner of implementing the various features and functionalities of the system 100 of the invention, and that other implementations are also possible. For instance, the GPS receiver 210, camera 212 and microphone 214, or other devices could each be provided with its own dedicated transmitter (not shown). In addition, transmission of signals from GPS receiver 210, camera 212 and microphone 214 can be conducted in real-time, at distinct intervals. Additionally, the system can be configured so that the GPS receiver 210, camera 212 and microphone 214 or other devices do not transmit their detected information, and instead store it for later review, using a storage device such as storage device 222, or they can both transmit and store this information.

FIG. 3 shows a system 300 in accordance with a further aspect of the invention. A handheld wireless local communication unit 302 is in RF communication with a suite of remote units mounted to collar 304. The remote units include a transceiver unit 306 configured to receive and transmit RF signals 308. These signals correspond to voice, tone and other signaling information being transmitted from the handler or operator at local communication unit 302, for example voice commands for the animal wearing the transceiver unit 306, or voice messages to a rescuee that the wearing animal has reached, consistent with the description above. They can also correspond to electronic commands transmitted from the local communication unit 302 to the transceiver unit 306 to cause the transceiver unit to issue tones or other types of signals of an audible, visible, or tactile (for example vibrations, mild electric shock, and so forth) or other sensory nature. Such electronic commands are triggered by the handler, for example when the handler presses an associated button on the local communication unit 302 or otherwise performs a particular action which triggers the desired response at the transceiver unit 306. They may also be triggered at the unit 306, for example by rescuee reached by the wearing animal, in which case the rescuee can press a button provided on the unit 306 to hear a pre-recorded message. For audible signals, including voice, one or more speakers such as speaker 310 is provided. Other sensory outputs are provided by other known types of transducers (LEDs for light, electrodes for electric shock, mechanical vibrators for vibrational signals, and so forth). It will be appreciated that the term “transducer” as used herein refers to any device that converts an electrical signal to a non-electrical signals, and vice versa. Other components of transceiver unit 306 are antenna 312 for receiving the RF signals 308 from local communication unit 302, and suitable circuitry (not shown) for converting and processing said received signals such proper triggering of audible, visible and other transducers is performed. A microphone 314 is also provided for detecting sounds from the environment of transducer unit 306, which sounds are then processed for transmission back to local communication unit 302 as described above. Although speaker 310 and microphone 314 are shown as part of one package, it will be appreciated that separate packages for these two components are possible.

The suite of remote units mounted to collar 304 and in communication with local communication unit 302 also includes GPS locator unit 316 and video camera unit 318 disposed in a different location on collar 304. GPS locator unit 316 can transmit location information to the handheld local communication unit 302 via antenna 319. Similarly, video camera unit 318 can transmit video information to the handheld local communication unit 302 via antenna 320. A mounting portion 321 is provided, which, as shown, consists of loops though which the collar 304 passes. Alternatively, complementary disengageable snaps (not shown) can be provided on both the unit 318 and collar 304. Velcro™, buttons, straps, and other means may also be provided as the mounting portion. As discussed above, it is contemplated that camera unit 318 and/or GPS locator unit 316 can be in communication with transceiver unit 306, either through direct wiring or wirelessly, such that they rely on some of the circuitry of transceiver unit 306 to effect communication with local communication unit 302. It is also contemplated that camera unit 318 and/or GPS locator unit 316 can be in the same package, and can be configured to store data for later review rather than, or in addition to, transmitting the data to local communication unit 302.

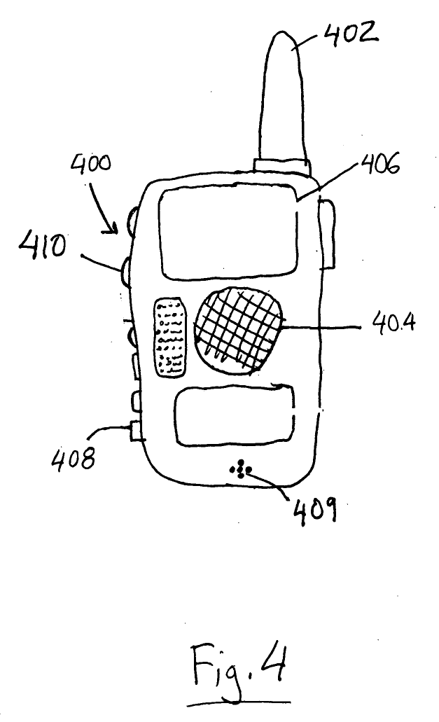

In FIG. 4, a handheld local communication unit 400, such as unit 302, is shown in greater detail. Antenna 402 receives RF signals from the suite of remote communication units worn by the animal. These signals are converted to electrical signals and processed for presentation to the operator. In the case of audio signals, they are presented as sounds by speaker 404. Similarly, visual information is presented on a display 406, for example configured to display video scenes from camera unit 318, and/or visual indications of location from GPS locator 316, and/or various other information such as status information, power information, and indications of inputs entered by the operator at the local communication unit 400. The information provided may be simple in nature, or it may include sophisticated displays of myriad information, such as images superimposed on a moving map, floor plan, schematic or other graphical device indicating where the moving animal is or has been relative to its environment. Multiple displays can also be used, each dedicated to a specific set of information, such as for video scenes from camera unit 318, status information, and so forth. Controls (not shown) may be provided to adjust the display parameters, such as brightness, power-down duration, and so on. Similar controls (not shown) can be provided to adjust the view provided from the camera unit 318, such as zoom, focus, and so forth. In input jack 408 is provided for connecting a headset (not shown), and at least one knob 410 can be provided for volume control of the headset and/or speaker 404. A microphone 409 is also provided for sound pick-up.

There are numerous applications for the system, devices and methods of the invention in addition to those described above. These include use for sending training or directional commands to a wearing animal. The system could also be used to warn people to stay back from the animal wearing the device. In the case of an animal being used as a companion animal to a person, the device could be used to send encouraging words to the person. Further, such a device could be used to provide mobility to Alzheimer's sufferers and others with serious disabilities. Such a disabled person could safely go for a walk with a dog fitted with the disclosed invention, because the disabled person would always be in voice contact with caregivers, and the caregivers would be able to track the location of the disabled person. Caregivers who take pets to retirement homes to comfort the lonely could provide additional cheer with a dog that not only offered something for the individual to pet but spoke to the individual by name. This would provide greater personal interaction, which would provide a greater sense of comfort to the recipient. Other applications include monitoring and interaction with elderly independent live-alones, companionship and monitoring capability for Alzheimer patients on walks.

In addition to the search and rescue, novelty caregiver and companionship applications of the invention, it is also contemplated that the invention can be used for security and patrol. As in the other applications, the invention, by way of the remote communication unit with the accompanying video, audio and locative and other information acquisition features provided, enables the handler at the local communication unit to know where the wearing animal is and to see and hear the surroundings of the animal where the animal is and what the animal is seeing and hearing, enabling a more interactive experience with the animal. Such an interaction is enhanced when coupled with the handler's ability to send commands to the animal, such as in which direction to travel, how far to travel, to move towards or away from objects of interest or potential harm, approach certain people, avoid others, and so forth. Specifically, the invention could greatly expand security and patrolling options such as in fenced-in equipment storage yards, warehouses or large areas that need to be patrolled or secured. A dog as the wearing animal for instance could cover the terrain much faster and, depending upon the equipment being used, provide real-time feedback to the handler, thus allowing the handler to limit those areas or situations which would deserve a closer inspection. Further, through voice commands the handler can direct the dog to specific locations prior to the handler having to inspect these areas himself. Such applications would in essence reduce the number of false alarms or unnecessary investigations because areas could be patrolled by the dog.

It will also be appreciate that the search and rescue applications of the invention include wilderness search and rescue, disaster search and rescue, and buildings search and rescue and/or evacuation. Using the invention, ground could be covered much faster, areas could be reviewed remotely and the dog or wearing animal can be given specific commands to search certain areas. This enables a dog to be handled in areas not visible to the handler, in the dark and over distances or in high sound ambient situations where hand-signals or yelling commands to the dog are ineffective. The invention, when using the preferred non-cellular type of wireless communication, is particularly useful in search and rescue situations in wilderness because of the potential absence of cell phone coverage or in disaster situations where cell phones may be inoperable and consequently would be useless as a means of telemetry to and from the dog.

An example of a novelty application of the invention is as follows: A pet owner could talk into his local communication unit and his voice would be heard from the speaker on his pet's collar giving the impression the pet is speaking. As entertainment for children, adults or a party gag this interaction with the pet allows the owner to fantasize how his pet (or how THE OWNER) would talk to other people. The owner becomes a “Pettriloquist,” talking to others through his pet.

This would prove a significant icebreaker providing liberties that one could take with others, for example of the opposite sex, at the dog-park, coffee house or any setting, and not be perceived as offensive. A pet owner could also at a distance have a conversation through the pet with someone else. The voice synthesizer of the invention could modify the owner's voice to a breed-specific selection. For instance, the owner's voice would be masked big and burly for a Saint Bernard or soft and squeaky for a Pekinese. The situations where individuals could derive amusement from being a “Pettriloquist” is limited only by ones imagination, for example, a four member family with three dogs singing Happy Birthday to mom. Of course the invention is not limited to dogs and is equally applicable to other domesticated animals, such as cats, potbellied pigs and horses.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A communication system comprising:
a local communication unit; and
a remote communication unit in wireless communication with the local communication unit, the remote communication unit configured to be mountable to an animal and to present to said animal or to a person in the vicinity of said animal an action that is initiated at the local communication unit.

2. The system of claim 1, wherein said action is a voice message.

3. The system of claim 2, wherein said voice message is live.

4. The system of claim 1, wherein said action is an audible tone.

5. The system of claim 1, wherein said action is visual message.

6. The system of claim 1, wherein the remote communication unit is configured to convey information to the local communication unit.

7. The system of claim 6, wherein the conveyed information pertains to the location of the remote communication unit.

8. The system of claim 6, wherein the conveyed information pertains to the sounds in the vicinity of the remote communication unit.

9. The system of claim 6, wherein the conveyed information pertains to images of the vicinity of the remote communication unit.

10. A remote communication unit configured for wireless communication with a local communication unit, the remote communication unit comprising:
a mounting portion for mounting the remote communication unit to an animal;
a communication circuit configured to receive signals from the local communication unit; and
at least one transducer for presenting information to the animal or to a person in the vicinity of the animal in response to the received signals.

11. The remote communication unit of claim 10, wherein said mounting portion engages a collar, harness or saddle worn by the animal.

12. The remote communication unit of claim 10, wherein the received signals correspond to a command initiated by an operator of the local communication unit

13. The remote communication unit of claim 12, wherein the command is a voice command.

14. The remote communication unit of claim 13, wherein the command is stored in the remote communication unit.

15. The remote communication unit of claim 10, wherein the transducer is a loudspeaker

16. The remote communication unit of claim 10, wherein the transducer is an LED.

17. A local communication unit configured for wireless communication with a remote communication unit adapted for mounting to an animal, the local communication unit comprising:
an input device through which an operator initiates an activity at the remote communication unit; and
a communication circuit configured to send signals associated with said activity to the remote communication unit.

18. The local communication unit of claim 17, wherein the activity is a voice message.

19. The local communication unit of claim 17, wherein the voice message is pre-recorded.

20. The local communication unit of claim 17, wherein the voice message is presented in real-time.

21. A communication method comprising:
initiating a message at a first location; and
presenting the message at a second location using a transducer mounted to an animal.

22. The method of claim 21, wherein the message is a pre-recorded voice message.

23. The method of claim 21, wherein the message is stored at the second location.

24. The method of claim 21, wherein the message is a live voice message from an operator at the first location.

25. The method of claim 21, further comprising sending information from the second location to the first location.

26. The method of claim 25, wherein the information is visual.

27. The method of claim 25, wherein the information is auditory.

28. The method of claim 25, wherein the information identifies the second location.

29. A communication system comprising:
means for initiating a message at a first location; and
means for presenting the message at a second location using a transducer mounted to an animal.

30. A method for conducting a search and/or patrol operation comprising:
dispatching a non-human animal to a search site;
wirelessly transmitting from the animal one or more locative, visual and auditory information pertaining to the animal's environment; and
wirelessly sending messages to the location of the animal.

31. The method of claim 30, wherein the messages are commands to the animal.

32. The method of claim 30, wherein the messages are people in the vicinity of the animal.
